(19) United States
(12) Patent Application Publication
(10) Pub. No.: US 2020/0410790 A1
(43) Pub. Date: Dec. 31, 2020

(54) CAMERA SYSTEM AND SENSORS FOR VEHICLE

(71) Applicant: Toyota Motor Engineering & Manufacturing North America, Inc., Plano, TX (US)

(72) Inventors: Derek A. Thompson, Ypsilanti, MI (US); Derek L. Lewis, Monroe, MI (US); Douglas Bates, South Lyon, MI (US)

(21) Appl. No.: 16/455,519

(22) Filed: Jun. 27, 2019

(51) Int. Cl. G07C 5/08; G01N 21/88; G07C 5/12; G07C 5/00; G05D 1/02; H04N 7/18

(52) U.S. Cl. CPC G07C 5/0866; G01N 21/8851; G07C 5/0808; B60R 11/04; G07C 5/008; G05D 1/0212; H04N 7/18; G07C 5/12

(57) ABSTRACT

Camera systems for allowing a rider (e.g., a driver, a passenger or an owner of a vehicle) to view all or a portion of a rider compartment or a storage compartment of a vehicle. The images from the cameras may be provided on a display for view by one or more of the riders. The display may be provided on a dash or mobile communication device of the rider. The view of the cameras shown on the display may be varied by the rider to view various portions of the rider compartment or the storage compartment. The systems, methods, and devices may be utilized with ride hailing services, and may be utilized with semi-autonomous or autonomous vehicles.

### BACKGROUND

### Field

This disclosure relates to camera systems for vehicles, and sensors for detecting activity within a rider compartment or a storage compartment of a vehicle. The systems may be utilized with ride hailing services and autonomous vehicles.

### Description of the Related Art

Vehicles typically include an array of mirrors that allow the driver to see the surrounding areas. Such mirrors may include a rear view mirror and side view mirrors that are utilized to see surrounding vehicles and other structures. Such devices, however, do not allow for a view of the interior of the vehicle, including a rider compartment or a storage compartment of the vehicle. Further, such devices are not easily controllable to view the interior of a vehicle.

A driver may turn one's head to view the interior of the vehicle, but risks damage to the vehicle caused by taking one's eyes off of the road momentarily.

As such, it may be difficult for a driver or other rider of a vehicle to ascertain activity taking place within the vehicle. The driver or other rider may particularly want to ascertain activity within the vehicle when small children are in the vehicle, or objects are within the storage compartment of the vehicle, or damage to the vehicle's interior may possibly occur. Also, in semi-autonomous or autonomous vehicles, the driver or the owner of the vehicle may want to make sure the riders are not sick, not doing something inappropriate or causing damage to the interior of the vehicle.

### SUMMARY

Aspects of the present disclosure are directed to systems, methods, and devices for camera systems for vehicles and sensors for vehicles. Aspects of the present disclosure are directed to systems, methods, and devices for determining a presence of damage to a rider compartment or a storage compartment of a vehicle. Aspects of the present disclosure are directed to systems, methods, and devices for camera recording systems for a rider compartment or a storage compartment of a vehicle. Aspects of the present disclosure are directed to systems, methods, and devices for determining a presence of an object left in a rider compartment or a storage compartment of a vehicle.

In one aspect, a system for determining a presence of damage to a rider compartment or a storage compartment of a vehicle is disclosed. The system may include one or more sensors configured to detect activity within the rider compartment or the storage compartment of the vehicle, and an electronic control unit. The electronic control unit may be configured to receive one or more signals of the activity from the one or more sensors, determine the presence of damage to the rider compartment or the storage compartment of the vehicle based on the one or more signals, and produce an output based on the determination of the presence of damage to the rider compartment or the storage compartment of the vehicle.

In one aspect, a camera recording system for a rider compartment or a storage compartment of a vehicle is disclosed. The system may include one or more sensors configured to detect activity within the rider compartment or the storage compartment of the vehicle and including at least one camera. The system may include a memory configured to record at least one image from the at least one camera, and an electronic control unit. The electronic control unit may be configured to receive one or more signals of the activity from the one or more sensors, determine whether a defined activity has occurred within the rider compartment or the storage compartment of the vehicle based on the one or more signals of the activity from the one or more sensors, and cause the memory to automatically record the at least one image from the at least one camera based on the determination of whether the defined activity has occurred within the rider compartment or the storage compartment of the vehicle.

In one aspect, a system for determining a presence of an object left in a rider compartment or a storage compartment of a vehicle is disclosed. The system may include one or more sensors configured to detect the object within the rider compartment or the storage compartment of the vehicle, and an electronic control unit. The electronic control unit may be configured to receive one or more signals of a detection of the object within the rider compartment or the storage compartment of the vehicle from the one or more sensors, determine whether the object has been left in the rider compartment or the storage compartment of the vehicle after a rider has left the vehicle, and produce an output based on the determination of whether the object has been left in the rider compartment or the storage compartment of the vehicle after the rider has left the vehicle.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale, and may be exaggerated to better illustrate the important features of the present disclosure.

FIG. 1 illustrates a schematic top cross-sectional view of a vehicle and components of a system according to an embodiment of the present disclosure.

FIG. 2 illustrates a perspective view of a front of a vehicle according to an embodiment of the present disclosure.

FIG. 3 illustrates a plan view of a mobile communication device according to an embodiment of the present disclosure.

FIG. 4 illustrates a flowchart of a method according to an embodiment of the present disclosure.

FIG. 5 illustrates a perspective view of a rear seat according to an embodiment of the present disclosure.

FIG. 6 illustrates a plan view of a mobile communication device according to an embodiment of the present disclosure.

FIG. 7 illustrates a flowchart of a method according to an embodiment of the present disclosure.

FIG. 8 illustrates a perspective view of a rear seat according to an embodiment of the present disclosure.

FIG. 9 illustrates a plan view of a mobile communication device according to an embodiment of the present disclosure.

FIG. 10 illustrates a flowchart of a method according to an embodiment of the present disclosure.

FIG. 11 illustrates a perspective view of a rear seat according to an embodiment of the present disclosure.

FIG. 12 illustrates a top view of a storage compartment of a vehicle according to an embodiment of the present disclosure.

FIG. 13 illustrates a plan view of a mobile communication device according to an embodiment of the present disclosure.

### DETAILED DESCRIPTION

Disclosed herein are camera systems for allowing a rider (e.g., a driver, a passenger or an owner of the vehicle) to view all or a portion of a rider compartment or a storage compartment of a vehicle. The images from the cameras may be provided on a display for view by one or more of the riders. The display may be provided on a dash or a mobile communication device of the rider or a remote user (e.g., an owner of the vehicle). The views of the cameras shown on the display may be adjusted or varied by the rider to view various portions of the rider compartment or the storage compartment. The images (with or without audio) from the cameras may be recorded if desired by the rider. In one embodiment, a system may be provided that allows for a determination of damage to the rider compartment or the storage compartment of the vehicle. In one embodiment, a camera system may be provided that automatically records images from within the vehicle upon a defined activity occurring within the vehicle. In one embodiment, a system may be provided that allows for a determination of an object left in the vehicle. The systems, methods, and devices disclosed herein may be utilized with ride hailing services, and may be utilized with semi-autonomous or autonomous vehicles.

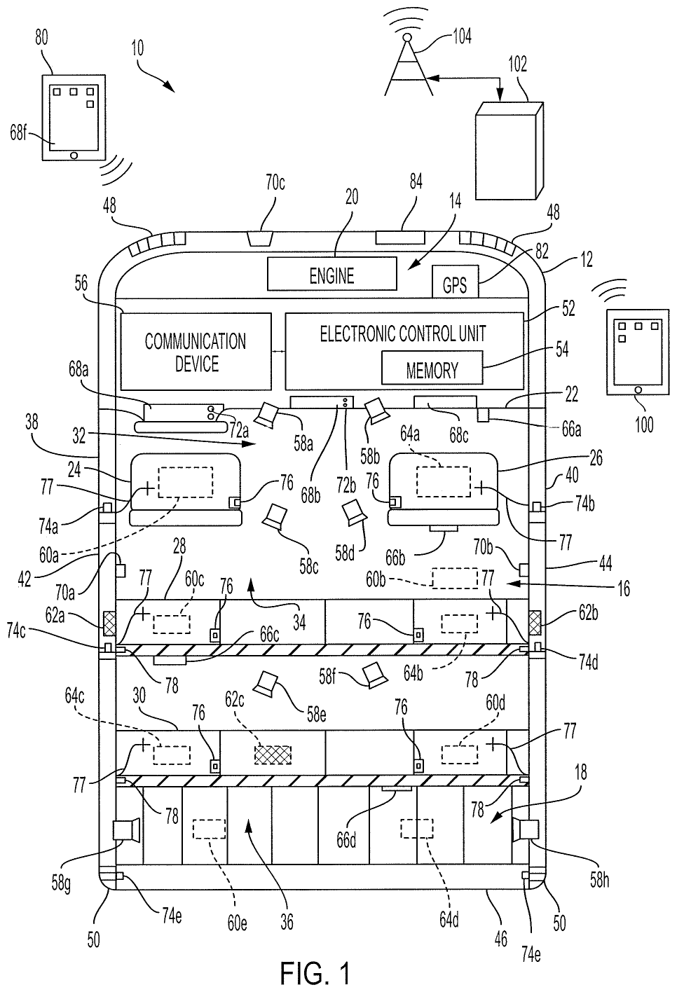

FIG. 1 illustrates a system 10 according to an embodiment of the present disclosure. The system 10 may be configured to perform the methods and operations disclosed herein. The system 10, or components thereof, may be integrated with a vehicle 12. The vehicle 12 is shown in a schematic top cross-sectional view in FIG. 1. The vehicle 12 may include a variety of different kinds of vehicles. The vehicle 12 may comprise a gasoline powered vehicle, or an electric powered vehicle, a hybrid gasoline and electric vehicle, or another type of vehicle. The vehicle 12 may comprise a sedan, a wagon, a sport utility vehicle, a truck, a van, or other form of vehicle. The vehicle 12 may comprise a four wheeled vehicle or in other embodiments may have a different number of wheels. As depicted, the vehicle 12 comprises a sport utility vehicle.

The vehicle 12 may include an engine compartment 14 and may include a rider compartment 16 and a storage compartment 18. The engine compartment 14 may be configured to contain the engine 20, which may be covered by a hood or the like. A front dash 22 may be positioned between the engine compartment 14 and the rider compartment 16.

The rider compartment 16 may be configured to hold the riders (e.g., driver, passengers) of the vehicle 12. The rider compartment 16 may include seats for carrying the riders. The seats may include a driver seat 24, a front passenger seat 26, and rear passenger seats. The rear passenger seats may include a rear row of seats, which may comprise a second row 28 of seats, and may include another rear row of seats, which may comprise a third row 30 of seats.

The rider compartment 16 may include a floor, which may include a front floor area 32 (such as the floor around the driver seat 24 and the front passenger seat 26), and a rear floor area 34. The rear floor area 34 may be the floor area around the rear rows of seats, including a second row 28 and a third row 30 of seats.

The storage compartment 18 may include a trunk, for storing objects such as luggage or other objects. The storage compartment 18 may include a floor area 36 for objects to be placed upon. The storage compartment 18 may comprise a closed compartment (such as a trunk for a sedan) or may be an open compartment to the rider compartment 16 such as in an embodiment in which the vehicle is a sport utility vehicle or a wagon or configured similarly.

The vehicle 12 may include doors. The doors may include front doors (such as a driver side door 38, and a front passenger side door 40). The doors may include rear doors (such as a left side rear door 42, and a right side rear door 44). The vehicle 12 may include folding or otherwise movable rear passenger seats that provide access to the third row 30 of seats. The vehicle 12 may include folding or otherwise movable rear seats (such as the third row 30 of seats) that provide access to the storage compartment 18.

The doors may include a rear door 46 that allows for access to the storage compartment 18. The rear door 46 may comprise a gate or may comprise a trunk lid.

The vehicle 12 may include lights in the form of front lights 48 (such as headlights), rear lights 50 (such as tail lights), and other lights such as side lights or interior lights such as dome lights or the like.

The system 10 may include multiple components, which may include an electronic control unit (ECU) 52. The ECU 52 may include a memory 54. The system 10 may include a communication device 56, which may be configured for communicating with other components of the system 10 or other components generally. The system 10 may include one or more sensors 58, 60, 62, 64, 66. The system 10 may include one or more displays 68, and may include one or more indicator devices 70. The system 10 may include controls 72. The system 10 may include door sensors 74, seat belt sensors 76, and seat fold sensors 78. The system 10 may include a software application, which may be for use by a rider. The system 10 may include a mobile communication device 80 that may be utilized by a rider, and may operate the software application. The system 10 may include a global positioning system (GPS) device 82.

The electronic control unit (ECU) 52 may be utilized to control the processes described herein. The ECU 52 may include one or more processors. The processors may be local to the ECU 52 or may be distributed in other embodiments. For example, a cloud computing environment may be utilized to perform the processing of the ECU 52 in certain embodiments. The one or more processors may include special purposes processors that are configured to perform the processes of the ECU 52. The ECU 52 may be integrated within the vehicle 12. As shown, the ECU 52 may be positioned within the front dash 22 or may be positioned in another location such as the engine compartment 14 or other part of the vehicle 12.

The ECU 52 may include a memory 54. The memory 54 may comprise random access memory (RAM), read only memory (ROM), a hard disk, solid state memory, flash memory, or another form of memory. The memory 54 may be local to the ECU 52 or may be distributed in other embodiments. For example, a cloud computing environment may be utilized to distribute data to a remote memory 54 in certain embodiments.

The memory 54 may be configured to store data that may be utilized by the ECU 52 and other components of the system 10. The data may include instructions for performing the processes disclosed herein. In embodiments, the memory 54 may be configured to record data received from components of the system 10. The data recorded may include at least one image produced by one or more cameras 58 of the system 10.

The communication device 56 may be utilized for communicating with the ECU 52, or other components of the system 10, or other components generally. The communication device 56 may be a wireless or wired communication device. In an embodiment in which the communication device 56 is a wireless communication device, the communication device 56 may communicate via local area wireless communication (such as Wi-Fi), or via cellular communication, or Bluetooth communication, or other forms of wireless communication. The communication device 56 may be configured to communicate with local devices, which may include devices in the vehicle 12 or near the vehicle 12 such as a mobile communication device 80. The communication device 56 may be configured for peer to peer wireless communication with devices that may be near the vehicle or remote from the vehicle. In embodiments, the communication device 56 may be configured to communicate with a remote device such as a cellular tower 104 or other signal router in certain embodiments. The communication device 56 may be configured to communicate with remote devices via cellular, radio, or another form of wireless communication.

The one or more sensors 58, 60, 62, 64, 66 may include various types of sensors. Each of the sensors 58, 60, 62, 64, 66 may be coupled to the vehicle 12, or otherwise integrated with the vehicle 12. The sensors 58, 60, 62, 64, 66 may be positioned in various locations as desired. For example, the sensors 58, 60, 62, 64, 66 may be positioned in or on the floor areas 32, 34, 36, the seats 24, 26, 28, 30, the walls, or the ceiling of the vehicle 12, as desired. Each of the sensors 58, 60, 62, 64, 66 may be visible within the vehicle 12 or may be hidden within the rider compartment 16 or the storage compartment 18 as desired. The one or more sensors 58, 60, 62, 64, 66 may be configured to detect activity within the rider compartment 16 or the storage compartment 18. The one or more sensors 58, 60, 62, 64, 66 may be configured to detect an object within the rider compartment 16 or the storage compartment 18.

The one or more sensors may include one or more cameras 58a-h. Each camera 58a-h may be configured to view an area of the rider compartment 16 or the storage compartment 18. For example, camera 58a may be configured to view the driver area. Camera 58b may be configured to view the front passenger area. Cameras 58c and 58d may be configured to view the rear passenger area. The rear passenger area may include the second row 28 of seats. Cameras 58e and 58f may be configured to view the rear passenger area, which may include the third row 30 of seats. Cameras 58g and 58h may be configured to view the storage compartment 18. The one or more cameras 58 may be configured to capture at least one image of the rider compartment 16 or the storage compartment 18.

Cameras 58a-h are shown in FIG. 1, although in other embodiments a greater or lesser number of cameras and the position of the cameras may be varied. For example, a single camera may be utilized in embodiments. The one or more cameras 58 may be positioned in or on floor areas 32, 34, 36, the seats 24, 26, 28, 30, the walls, or the ceiling of the vehicle 12, as desired. The one or more cameras 58 may be coupled to the vehicle 12. The one or more cameras 58 may be hidden in embodiments. The one or more cameras 58 may be configured to have a variety of views as desired, for example the one or more cameras 58 may view rearward, or view forward, or to a side. As an example, in an embodiment in which a child or infant car seat is positioned in the vehicle 12, one or more of the cameras may be directed forward to allow for view of the child's or infant's face. In an embodiment in which a single camera is utilized, the camera may view the entirety of the interior of the vehicle 12. For example, a large 360 degrees camera, or other form of camera may be utilized. Each camera 58 may be configured to send signals to the electronic control unit 52.

The one or more sensors may include one or more moisture sensors 60a-e. Each moisture sensor 60a-e may be configured to detect the presence of moisture in an area in the rider compartment 16 or the storage compartment 18. For example, moisture sensor 60a may be configured to detect moisture of the driver seat 24. Moisture sensor 60b may be configured to detect moisture of the rear floor area 34. Moisture sensor 60c may be configured to detect moisture of the second row 28 of passenger seats. Moisture sensor 60d may be configured to detect moisture of the third row 30 of passenger seats. Moisture sensor 60e may be configured to detect moisture of the storage compartment 18, for example, the floor area 36 of the storage compartment 18. The location of the moisture sensors 60a-e and the location of the sensed moisture may be varied as desired. For example, the position of the moisture sensors 60a-e may be varied from the position shown in FIG. 1. Each moisture sensor 60 may be coupled to a location as desired in the vehicle 12, which may include in or on floor areas 32, 34, 36, the seats 24, 26, 28, 30, or the walls. In one embodiment, a greater or lesser number of moisture sensors 60 may be utilized as desired. For example, in one embodiment a single moisture sensor may be utilized. Each moisture sensor 60 may be configured to send signals to the electronic control unit 52.

The one or more sensors may include one or more audio sensors 62a-c. The audio sensors 62a-c may each be in the form of microphones or another form of audio sensor. Each audio sensor 62a-c may be configured to detect audio within the rider compartment 16 or the storage compartment 18. For example, audio sensors 62a and 62b may each be configured to detect audio within the second row 28 of passenger seats. Audio sensor 62c may be configured to detect audio within the third row 30 of passenger seats. The location of the audio sensors 62a-c and the location of the sensed audio may be varied as desired (e.g., the driver area or the storage compartment, among other locations). For example, the position of the audio sensors 62a-62c may be varied from the position shown in FIG. 1. Each audio sensor 62 may be coupled to a location as desired in the vehicle 12, which may include in or on floor areas 32, 34, 36, the seats 24, 26, 28, 30, the walls, or the ceiling. In one embodiment, a greater or lesser number of audio sensors 62 may be utilized as desired. For example, in one embodiment a single audio sensor may be utilized. Each audio sensor 62 may be configured to send signals to the electronic control unit 52. Each audio sensor 62 may be independently or in combination controlled to be turned on and off and for the volume to be adjusted using the electronic control unit 52. For example, a particular state or country law may prohibit recording video and/or audio without the consent of the person being recorded. Therefore, the electronic control unit 52 may be programmed at the factor or may be adjusted by the user to comply with the applicable law. The display 68 may also be a touch screen to allow the person being recorded to consent to the recording prior to activation of the cameras 58 and/or the audio sensors 62.

The one or more sensors may include one or more pressure sensors 64a-64d. The pressure sensors 64a-64d may each be in the form of piezoelectric, capacitive, electromagnetic, strain sensors, optical sensors, or other forms of pressure sensor. Each pressure sensor 64a-64d may be configured to detect the presence of pressure within the rider compartment 16 or the storage compartment 18. For example, pressure sensor 64a may be configured to detect pressure on the front passenger seat 26. Pressure sensor 64b may be configured to detect pressure of the second row 28 of passenger seats. Pressure sensor 64c may be configured to detect pressure of the third row 30 of passenger seats. Pressure sensor 64d may be configured to detect pressure of the storage compartment 18. The location of the pressure sensors 64a-64d and the location of the sensed pressure may be varied as desired. For example, the position of the pressure sensors 64a-64d may be varied from the position shown in FIG. 1. Each pressure sensor 64 may be coupled to a location as desired in the vehicle 12, which may include in or on floor areas 32, 34, 36, the seats 24, 26, 28, 30, or the walls. Each pressure sensor 64 may be configured to detect pressure on a seat, or on the floor. In one embodiment, a greater or lesser number of pressure sensors 64a may be utilized as desired. For example, in one embodiment a single pressure sensor may be utilized. Each pressure sensor 64 may be configured to send signals to the electronic control unit 52.

The one or more sensors may include one or more motion sensors 66a-66d. The motion sensors 66a-66d may be in the form of infrared, microwave, or ultrasonic sensors, and may include sensors that are doppler shift sensors, or other forms of motion sensors. Each motion sensor 66a-66d may be configured to detect motion within the rider compartment 16 or the storage compartment 18. For example, motion sensor 66a may be configured to detect motion on the front passenger seat 26. Motion sensor 66b may be configured to detect motion on the second row 28 of passenger seats. Motion sensor 66c may be configured to detect motion on the third row 30 of passenger seats. Motion sensor 66d may be configured to detect motion in the storage compartment 18. The location of the motion sensors 66a-66d and the location of the sensed motion may be varied as desired. For example, the position of the motion sensors 66a-66d may be varied from the position shown in FIG. 1. Each motion sensor 66 may be coupled to a location as desired in the vehicle 12, which may include in or on floor areas 32, 34, 36, the seats 24, 26, 28, 30, the walls, or the ceiling. Each motion sensor 66 may be configured to detect motion on a seat, or on the floor. In one embodiment, a greater or lesser number of motion sensors 66 may be utilized as desired. For example, in one embodiment a single motion sensor may be utilized. Each motion sensor 66 may be configured to send signals to the electronic control unit 52.

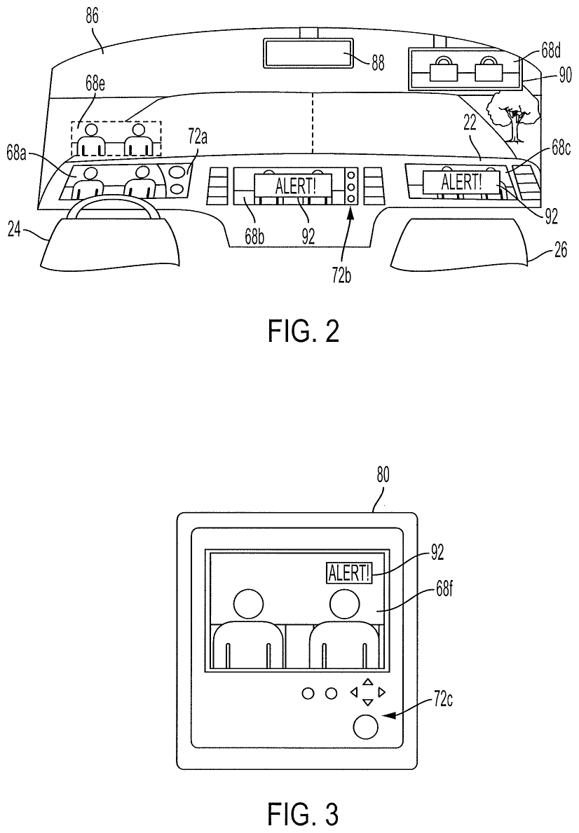

The one or more displays 68 may be positioned as desired within the vehicle 12. The one or more displays 68 may include a meter display 68a, a media display 68b, and a dash display 68c. The one or more displays 68 may include a sun visor display 68d and a heads up display 68e (as marked in FIG. 2) in embodiments as desired. The displays 68 in embodiments may be positioned on seats (including the rear of seats), walls, or ceilings. The displays 68 may be coupled to the vehicle 12 in desired locations.

The one or more displays 68 may comprise display screens. The display screens may be configured to display images from the one or more cameras 58a-h, and may be configured to display other indicators produced by the system 10. In one embodiment, a display 68f may be a display of a mobile communication device 80 (as marked in FIG. 1). The display 68f may be configured to display images from the one or more cameras 58a-h, and may be configured to display other indicators produced by the system 10. The display 68f may be configured to receive the images or the indicators wirelessly via the communication device 56 and via a wireless communication device (e.g., WiFi or Bluetooth) of the mobile communication device 80. The number and location of the displays 68 may be varied in embodiments as desired. For example, in one embodiment only one display may be utilized.

The one or more indicator devices 70 may be positioned as desired on the vehicle 12. The indicator devices 70 may be configured to provide an indication within the vehicle 12 or exterior to the vehicle. The indicator device 70a, for example, may comprise an interior light that may be used to illuminate to provide an indication. The indicator device 70b, for example, may comprise an interior speaker that may be used to produce a sound to provide an indication. Another form of indicator device 70c may comprise an exterior speaker, such as a car horn, that may be used to produce an exterior sound to provide an indication. Exterior lights, such as head lights 48 or tail lights 50 may be used to illuminate to provide an exterior indication. In embodiments, other forms of indication may be utilized, such as haptic if desired. The indicator devices 70 may be used to provide an indication (such as light, sound, or motion) of a determination by the electronic control unit 52. The indication may be in response to an output from the electronic control unit 52. Other indications may be displayed on one or more of the displays 68 (which may be on a mobile communication device 80), or other components.

The controls 72 may be utilized to control operation of components of the system 10. The controls 72 may comprise buttons, dials, toggles, or other forms of physical controls, or may be electronic controls. For example, controls 72a (as shown in FIG. 2) may be physical controls such as knobs or buttons on the front dash of the vehicle 12. Controls 72b (as shown in FIG. 2) may be electronic controls such as touchscreen controls. The controls 72 may be coupled to the vehicle 12 and may be positioned on the front dash or another part of vehicle as desired, including on display screens. The controls 72 may be utilized to select modes of operation of the system 12. The controls 72 may be utilized to control a view of one or more of the cameras 58. In one embodiment, controls 72c may be positioned on a mobile communication device 80, for example as shown in FIG. 3. In embodiments, the controls may include control with voice commands or detected gestures, among other forms of controls.

The door sensors 74 may be configured to detect the opening and closing of doors 38, 40, 42, 44, 46. The door sensor 74a may be configured to detect the opening and closing of the driver side door 38, and the door sensor 74b may be configured to detect the opening and closing of the front passenger side door 40. The door sensors 74c, 74d may be configured to detect the opening and closing of the left side rear door 42 and the right side rear door 44. The door sensors 74e may be configured to detect the opening and closing of the rear door 46 (e.g., rear gate or trunk). The seat belt sensors 76 may be configured to detect whether a respective seat belt 77 is engaged with the respective seat belt buckle. The seat fold sensors 78 may be configured to detect whether the respective seats (for example, the second row 28 or the third row 30 of seats) are folded for a passenger to access the third row 30 or another rear portion, or the storage compartment 18.

A software application may be operated on the mobile communication device 80 or another device as desired. For example, the software application may be utilized to control the cameras 58 of the system 10, including controlling recording from the cameras 58 and controlling what view from the cameras 58 is displayed. The software application may be utilized to produce indicators that that may be produced based on the detections of sensors 58, 60, 62, 64, 66. The software application may be stored in a memory of the mobile communication device 80 or other device and operated by a processor of the mobile communication device 80 or other device. The software application may be dedicated software for use by the system 10. The mobile communication device may comprise a smartphone or other mobile computing device such as a laptop or the like. The mobile communication device 80 may be configured to communicate with the electronic control unit 52 wirelessly via the communication device 56.

The global positioning system (GPS) device 82 may be utilized to determine the position and movement of the vehicle. The GPS device 82 may be utilized for navigation and for guidance. The system 10 may be configured to communicate the position and movement of the vehicle 12 wirelessly via the communication device 56 to remote devices such as servers, or may be configured to provide such information locally to a device such as the mobile communication device 80.

In one embodiment, the vehicle 12 may be an autonomous vehicle. The electronic control unit (ECU) 52 may be configured to operate the vehicle 12 in an autonomous manner, including controlling driving of the vehicle 12. The GPS device 82 may be utilized to determine the position and movement of vehicle for use in autonomous driving. Driving sensors 84, such as optical sensors, light detection and ranging (LIDAR), or other forms of driving sensors 84, may be utilized to provide input to the ECU 52 to allow the ECU 52 to control driving of the vehicle 12.

The system 10 may be utilized to allow an individual to view the rider compartment 16 or the storage compartment 18. The individual may be a rider (including a driver or a passenger) of the vehicle 12. The individual may view the rider compartment 16 or the storage compartment 18 via the one or more cameras 58.

FIG. 2, for example, illustrates a representation of a display of the images from the one or more cameras 58. The front dash 22 is visible as well as the front windshield 86 and the rear view mirror 88. The back of the driver seat 24 and the back of the front passenger seat 26 are visible. The displays 68a, 68b, 68c, 68d, 68e may show the images of one or more cameras 58. The display 68a, for example, may be a meter display 68a that may be located in the same area as other meters for the vehicle 12, such as the speedometer, the tachometer, or the fuel gauge, among other meters. The display 68b may be a media display that may be positioned on the front dash 22. The media display may provide information on media played by the vehicle 12 (such as a radio) and may provide other information such as temperature control or other settings of the vehicle 12. The media display may provide various displays of information other than the images produced by the cameras 58. The display 68c may be a front dash display. The display 68d may be positioned on the sun visor 90. The display 68e may be a heads up display that is presented to the riders (particularly the driver). Other locations of displays may be utilized than shown in FIG. 2.

The view provided on the displays 68 may be of the rider compartment 16. For example, a view of the second row 28 is shown in FIG. 2. Two riders, such as two children, are shown on the displays 68a, 68b, 68c, 68e. The children are seated in the second row 28. Other views of the rider compartment 16 may be provided as desired. For example, a view of the third row 30, or the front passenger seat 26, or another portion of the rider compartment 16 may be provided. Multiple different views may be provided on the displays 68 simultaneously. For example, a view of the storage compartment 18 showing luggage may be provided on another display, such as display 68d shown in FIG. 2. Multiple different views may be provided on the same display, or on different displays as shown in FIG. 2.

The controls 72 may be utilized to control the view provided on the displays 68. In an embodiment in which multiple cameras 58 are utilized, the controls 72 may be utilized to switch which camera 58 view is provided. In an embodiment in which one or more of the cameras 58 is movable, or a view of the camera is movable, the controls 72 may be utilized to move a camera or a view of a camera. One or more of the cameras 58 may be movably coupled to the vehicle 12. The controls 72 may be utilized to zoom a view of a camera 58. The controls 72 may be utilized by an individual to select whether the rider compartment 16 or the storage compartment 18 is shown, and which portion of the rider compartment 16 or storage compartment 18 is shown.

The controls 72 may be utilized by an individual to select whether to record any of the images of the cameras 58. The individual may press a button or provide another input to cause the images of the cameras 58 to be recorded. The individual may cause other inputs to the sensors 60, 62, 64, 66 to be recorded. For example, audio detected by the audio sensors 62 may be recorded, and may be recorded along with the images of the cameras 58 to form a video recording with sound. The images or other inputs recorded by the system 10 may be transmitted to other devices for review and playback as desired.

The images of the cameras 58 may be shown on displays 68a-e that are coupled to the vehicle 12, as shown in FIG. 2. Referring to FIG. 3, the images of the cameras 58 may be shown on the display 68f of the wireless communication device 80. The images of the cameras 58 may be transmitted to the display 68f of the wireless communication device 80 wirelessly via the communication device 56 or the like. An individual may view of the display 68f on the wireless communication device 80 either within the vehicle 12, or outside of the vehicle 12 (either near the vehicle 12 or remotely from the vehicle 12). The wireless communication device 80 may include controls 72c, which may operate similarly as the controls shown in FIG. 2. The wireless communication device 80 may be configured to output audio that is detected by an audio sensor 62. The wireless communication device 80 may include a memory for recording the images of the cameras 58, and may be configured to record both audio and images (to form a video recording with sound).

The use of the cameras 58 and the displays 68 may allow an individual to view the rider compartment 16 or the storage compartment 18, or portions thereof. An individual such as a driver may be able to view passengers, including small children, within the vehicle 12. The driver may be able to view the passengers during transit to keep track of activity within the vehicle 12. The driver may be able to view the storage compartment 18 to view contents of the storage compartment 18. For example, the driver may be able to see if objects within the storage compartment 18 such as luggage, grocery bags, or other objects have moved during transit or have become damaged, among other properties. The driver may be able to control the view of the camera that is shown (for example, by controlling the cameras to change the view). Individuals other than the driver may view the images from the cameras 58, for example, another rider (such as a passenger in either the rear or the front passenger seat) may view the displays 68. An individual that is remote from the vehicle 12 may also be able to view the images from the cameras 58, which may be transmitted via the communication device 56. The individual may be able to control the view of what is shown and may be able to record the images (and record inputs to the other sensors 60, 62, 64, 66) as desired.

The system 10 may be configured to produce indicators that are provided to an individual, who may comprise a rider of the vehicle 12. The indicators may have a variety of forms, which may include a visual indicator 92 as shown in FIGS. 2 and 3. The visual indicator 92 may comprise an alert or the like indicating a condition to an individual. The indicators may provide an indication in response to a determination by the electronic control unit (ECU) 52. The indicators may be in response to an output from the ECU 52. Other forms of indicators may be utilized, such as a light provided by the indicator device 70a, or other lights of the vehicle 12, or a sound produced by the indicator device 70b in the form of a speaker.

The system 10 may be utilized to determine a presence of damage to the rider compartment 16 or the storage compartment 18 of the vehicle 12.

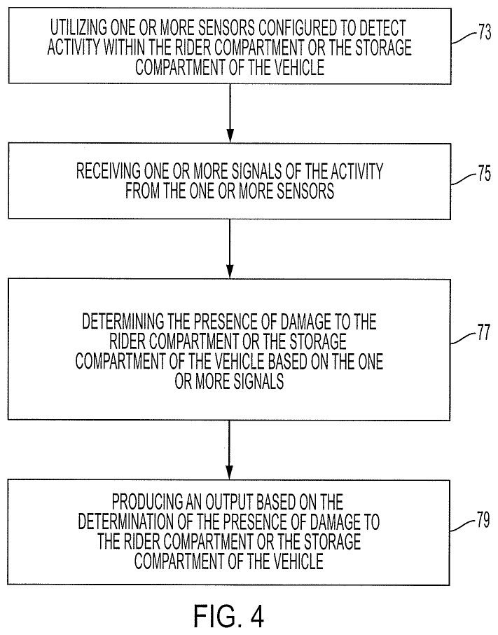

FIG. 4 illustrates steps in a method that may be utilized for the system 10 to determine a presence of damage to the rider compartment 16 or the storage compartment 18 of the vehicle 12. In step 73, the sensors 58, 60, 62, 64, 66 may be configured to detect activity within the rider compartment 16 or the storage compartment 18. The cameras 58 may be configured to view the activity within the rider compartment 16 or the storage compartment 18. The moisture sensors 60 may be configured to detect activity in the form of moisture. The audio sensors 62 may be configured to detect activity in the form of sound or a lack thereof. The pressure sensors 64 may be configured to detect activity in the form of pressure or movement. The motion sensors 66 may be configured to detect activity in the form of a physical presence or movement.

Each sensor 58, 60, 62, 64, 66 may produce a signal of the activity detected by the respective sensor 58, 60, 62, 64, 66. For example, one or more of the cameras 58 may produce a signal of the images detected by the camera 58, one or more of the moisture sensors 60 may produce a signal representing the moisture detected by the moisture sensor 60, one or more of the audio sensors 62 may produce a signal representing the audio detected by the audio sensor 62, one or more of the pressure sensors 64 may produce a signal representing the pressure or movement detected by the pressure sensor 64, one or more of the motion sensors 66 may produce a signal representing the physical presence or movement detected by the motion sensor 66. The respective signals may be transmitted to the electronic control unit 52 for processing.

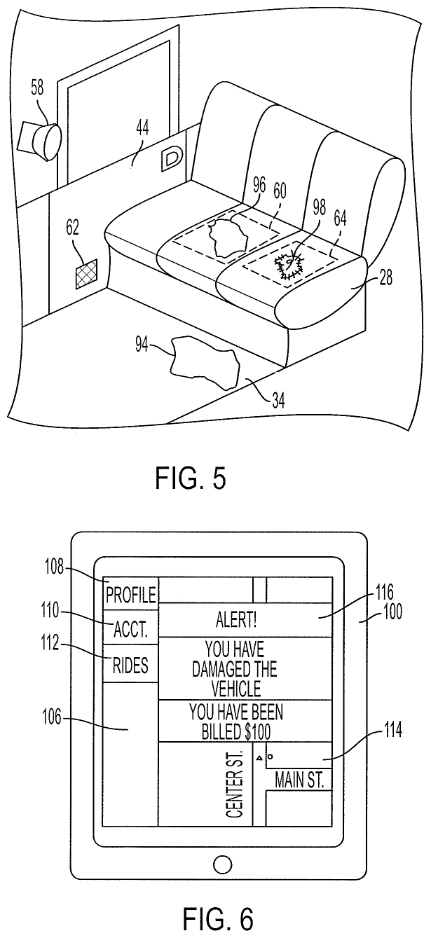

FIG. 5 illustrates an example of the activity that may be detected by the sensors. Sensors in the form of a camera 58, a moisture sensor 60, an audio sensor 62, and a pressure sensor 64 are shown in FIG. 5. Motion sensors 66 may be similarly utilized, although are not shown in FIG. 5. The sensors 58, 60, 62, 64 may be configured to detect activity of damage to the rider compartment 16, shown as a seat of the second row 28 and the rear floor area 34. The camera 58 may detect the activity visually. The moisture sensor 60 may detect the activity in the form of a variation in moisture. The audio sensor 62 may detect a sound of the activity. The pressure sensor 64 may detect a pressure or movement of the activity. A motion sensor 66 may detect a physical presence or movement of the activity.

The damage may include various forms of damage. The damage may include a material deposited within the rider compartment 16 or the storage compartment 18, or may include a variation in the integrity of at least a portion of the rider compartment 16 or the storage compartment 18, among other forms of damage. The material deposited, for example, may comprise mud, dirt, drinks, bodily fluids, or other liquids or materials. FIG. 5, for example, illustrates mud 94 positioned on the rear floor area 34. Bodily fluids 96 are illustrated positioned on the seat of the second row 28. A variation in the integrity of the rider compartment 16 in the form of structural damage (a puncture 98) of the seat is shown. The camera may detect the damage visually. The moisture sensor 60 may detect the presence of the bodily fluids 96 based on the presence of the liquid in the fluids (a moisture sensor may also be placed on the floor area 34 to detect the liquid of the mud 94). The pressure sensor 64 may detect the pressure and movement of the structural damage to the seat (a pressure sensor may also be used to detect the deposition of the mud 94 or bodily fluids 96). The audio sensor 62 may detect the sound of the mud 94 being deposited, or the sound of the bodily fluids 96 being deposited, or the sound of the structural damage to the seat. A motion sensor 66 may detect a physical presence or movement of the deposition of the mud 94 or bodily fluids 96, or the physical presence of movement of the structural damage to the seat.

The damage shown in FIG. 5 is exemplary, and other forms of damage may occur. The sensors 58, 60, 62, 64, 66 may be similarly configured to detect activity of damage in the storage compartment 18 or in another row of the seats, or in the front rider area of the vehicle 12 or another portion of the rider compartment 16. The configuration, number, and location of the sensors 58, 60, 62, 64, 66 may be varied in other embodiments as desired.

Referring back to FIG. 4, in step 75, the electronic control unit (ECU) may receive one or more signals of the activity from the one or more sensors 58, 60, 62, 64, 66. The ECU 52 may be configured to determine the presence of damage to the rider compartment 16 or the storage compartment 18 based on the signals provided by the one or more sensors 58, 60, 62, 64, 66.

In step 77, the ECU 52 may determine the presence of damage to the rider compartment 16 or the storage compartment 18 based on the signals from one or more of the sensors 58, 60, 62, 64, 66. For example, the ECU 52 may be configured to utilize signals from one of the sensors 58, 60, 62, 64, 66 or signals from a combination of sensors to provide the determination. In an embodiment in which only one or more cameras 58 are utilized, then only camera signals may be utilized by the ECU 52. In an embodiment in which only one or more moisture sensors 60 are utilized, then only moisture sensor signals may be utilized by the ECU 52. In an embodiment in which a combination of sensors is utilized (e.g., both cameras 58 and moisture sensors 60), then the ECU 52 may be configured to determine the presence of damage to the rider compartment 16 or the storage compartment 18 based on the combination of signals.

The ECU 52 may apply an algorithm to the signals provided by the one or more sensors 58, 60, 62, 64, 66 to determine the presence of damage to the rider compartment 16 or the storage compartment 18. The algorithm may be provided based on the type of signals provided by the one or more sensors 58, 60, 62, 64, 66. In an embodiment in which signals are received from one or more cameras 58, an image recognition algorithm may be applied to the signals from the one or more cameras 58. The image recognition algorithm may be applied to at least one image that is captured by the one or more cameras 58 to determine the presence of damage to the rider compartment 16 or the storage compartment 18. For example, the image recognition algorithm may be configured to identify visual features in the at least one image that indicate damage has occurred to the rider compartment 16 or the storage compartment 18.

In an embodiment in which signals are received from one or more moisture sensors 58, a moisture recognition algorithm may be applied to the signals from the one or more moisture sensors 58. For example, the ECU 52 may determine whether the moisture sensor 58 has detected moisture and may determine whether the moisture is sufficient in amount to constitute damage to the rider compartment 16 or the storage compartment 18.

In an embodiment in which signals are received from one or more audio sensors 62, an audio recognition algorithm may be applied to the signals from the one or more audio sensors 62 to determine the presence of damage to the rider compartment 16 or the storage compartment 18. For example, the audio recognition algorithm may be configured to identify audio features in the signal that match features associated with damage to the rider compartment 16 or the storage compartment 18, such as the sound of structural damage to the vehicle 12, or the sound of an object falling or liquid falling upon the rider compartment 16 or the storage compartment 18.

In an embodiment in which signals are received from one or more pressure sensors 64, a pressure recognition algorithm may be applied to the signals from the one or more pressure sensors 64 to determine the presence of damage to the rider compartment 16 or the storage compartment 18. For example, the pressure recognition algorithm may be configured to identify features in the signal that match features associated with damage to the rider compartment 16 or the storage compartment 18. The features may include pressure of an object or liquid falling upon the rider compartment 16 or the storage compartment 18. The features may include pressure or a variation in pressure indicating motion that indicates structural damage to the vehicle 12.

In an embodiment in which signals are received from one or more motion sensors 66, a motion recognition algorithm may be applied to the signals from the one or more motion sensors 66 to determine the presence of damage to the rider compartment 16 or the storage compartment 18. For example, the motion recognition algorithm may be configured to identify features in the signal that match features associated with damage to the rider compartment 16 or the storage compartment 18. The features may include motion of an object or liquid falling upon the rider compartment 16 or the storage compartment 18. The features may include movements that indicates structural damage to the vehicle 12.

The signals from one or more sensors 58, 60, 62, 64, 66 may be processed in combination to determine the presence of damage to the rider compartment 16 or the storage compartment 18. In an embodiment in which multiple sensors or types of sensors 58, 60, 62, 64, 66 are utilized, the signals from the multiple sensors or types of sensors 58, 60, 62, 64, 66 may be processed in combination. For example, if multiple cameras 58 are utilized, then the images from multiple cameras 58 may be processed in combination to determine the presence of damage. If cameras 58 and audio sensors 62 are both utilized, then the signals from the cameras 58 and the audio sensors 62 may both be processed in combination. The electronic control unit (ECU) 52 may make a determination based on the signals to determine the presence of damage to the rider compartment 16 or the storage compartment 18. For example, if the image algorithm determines the presence of damage, and the audio algorithm determines the presence of damage, then the ECU 52 may determine that damage has occurred. If the image algorithm determines the presence of damage, but the audio algorithm does not determine the presence of damage, then the ECU 52 may determine the image algorithm is not certain in the determination of damage, and that damage is not present. If the image algorithm and audio algorithm both determine that damage is not present, then the ECU 52 may determine that damage is not present. Multiple combinations of sensors or types of sensors 58, 60, 62, 64, 66 may be processed in combination for the ECU 52 to determine the presence of damage.

The ECU 52 may make a determination of the presence of damage to the rider compartment 16 or the storage compartment 18 utilizing a comparison to a prior state within the rider compartment 16 or the storage compartment 18. For example, the ECU 52 may receive the signals from the one or more sensors 58, 60, 62, 64, 66 during a prior state within the rider compartment 16 or the storage compartment 18. The ECU 52 may then receive the signals from the one or more sensors 58, 60, 62, 64, 66 during a later state and compare the signals from the later state to the prior state. The ECU 52 may then make a determination of the presence of damage based on the change from the prior state to the later state. For example, if cameras 58 are utilized, then the images from multiple cameras 58 during a prior state may be compared to images from the later state. If mud 94, for example, was not present on the rear floor area 34 during the prior state, and then mud 94 is present on the rear floor area 34 during a later state, then the ECU 52 may make a determination of the presence of damage to the rider compartment 16. Any of the signals from the sensors 58, 60, 62, 64, 66 may be compared from a prior state to a later state within the rider compartment 16 or the storage compartment 18, either solely or in combination to determine the presence of damage.

Sensors may be utilized to determine a transition between a prior state and a later state. Such sensors may include the door sensors 74, the seat belt sensors 76, and the seat fold sensors 78. Signals from such sensors may be transmitted to the ECU 52 for the ECU 52 to make a determination that a rider is present within the vehicle 12 by either entering or exiting the vehicle 12. For example, if the door sensors 74 detect a door has opened, and the seat belt sensor 76 detects that a seat belt has been engaged with a buckle, then the ECU 52 may determine that a rider is present in the vehicle 12. The time prior to the rider in the vehicle 12 may be considered a prior state for the vehicle 12 and the time following the rider being in the vehicle 12 may be considered a later state. The ECU 52 may compare the signals from the prior state to the later state to determine if the rider has provided damage to the vehicle 12. The comparison may occur after the rider leaves the vehicle 12, to determine damage the rider has left in the vehicle 12. The seat fold sensors 78 may be similarly utilized to determine if a rider has moved to the third row 30, or has accessed the storage compartment 18. The door sensors 74 may be similarly utilized to determine if the storage compartment 18 has been accessed and an object has been placed therein. Signals from one or more of the sensors 58, 60, 62, 64, 66 may also be utilized to determine a transition between a prior state and a later state.

In step 79, the ECU 52 may produce an output based on the determination of the presence of damage to the rider compartment 16 or the storage compartment 18. The output may be provided in a variety of forms. In one embodiment, the output may comprise an indicator provided to an individual of the damage. Referring to FIG. 2, the indicator may comprise a visual indicator 92 that is provided to an individual, and may be provided on one or more of the displays 68. The visual indicator 92 as shown in FIG. 2 may comprise a word, such as “alert,” or may have another form such as a symbol, a light, or another visual form. The visual indicator may comprise lights, including illumination by one or more of the indicator devices 70. In one embodiment, the indicator may be a sound produced by one or more of the indicator devices 70. The indicator may be produced either internally within the vehicle 12 or externally. For example, the front lights 48 or the rear lights 50, or the car horn, may illuminate or sound to provide an external indication. In one embodiment, an internal indicator device 70 in the form of a dome light or other form of internal light may illuminate to not only indicate the presence of damage, but also allow an individual to better see within the vehicle to address the damage. An indicator may be provided on a mobile communication device 80 or other device. For example, FIG. 3 illustrates a visual indicator 92 may be provided on the mobile communication device 80. The indicator may be provided remotely, on a remote device if desired.

In one embodiment, the output may comprise automatically switching a view of one or more of the displays 68 to display the presence of the determined damage. The ECU 52 may determine a location of the damage and display the damage on the view of the displays 68. For example, referring to FIG. 2, the displays 68a, 68b, 68c, and 68e show the second row 28 of seats. The display 68d shows the storage compartment 18. If the presence of damage is determined in the third row 30 of seats, then the view of one or more of the displays 68a-e may be switched to show the damage in the third row 30 of seats. An individual, such as a driver or front passenger may then be able to better assess and address the damage upon being shown the damage one or more of the displays 68a-e. In one embodiment, one or more of the cameras 58 may be moved or the view of the camera 58 may be otherwise varied (e.g., panned or zoomed) to provide a view of the damage. The view of a mobile communication device 80 as shown in FIG. 3 may also be switched to show the damage. The view of a remote device may also be switched to show the damage.

In one embodiment, the output may comprise automatically causing the presence of the damage to be recorded in the memory 54 or another form of memory. The detections from one or more of the sensors 58, 60, 62, 64, 66 may be automatically recorded that indicate the presence of the damage. In an embodiment in which cameras 58 are utilized, at least one image from the cameras 58 of the damage may be automatically recorded in the memory 54 or another form of memory. In an embodiment in which audio sensors 62 are utilized, the audio detected by the audio sensors 62 may be recorded, and may be recorded along with the images of the cameras 58 to form a video recording with sound. An individual may later play back the recording to assess what happened in the vehicle 12 and what may have caused the damage to occur. The output may comprise automatically causing the presence of the damage to be recorded in the memory of the mobile communication device 80 if desired. Other forms of output may be provided in other embodiments.

In one embodiment, the system 10 and the vehicle 12 may be utilized with a ride hailing service. The ride hailing service may be a third party ride hailing service, or may be a ride hailing service of the provider of the system 10 or vehicle 12. The ride hailing service may allow users to request rides from the vehicle 12.

The ride hailing service may utilize a software application. The software application may be dedicated for use by the ride hailing service. Referring to FIG. 1, the software application may be utilized on a mobile communication device 100 of a user of the ride hailing service. The software application may be utilized by the user to request a ride from the vehicle 12, coordinate the pick up location of the user, coordinate a drop off location of the user, and may handle payment by the user for a ride by the vehicle 12, among other features.

The software application of the mobile communication device 100 may utilize a global positioning system (GPS) device of the mobile communication device 100 to identify a location of the user. The GPS device may allow the driver of the vehicle 12 to determine the location of the user and pick up the user such that the user is a rider of the vehicle 12. In one embodiment, another form of computing device other than a mobile communication device, such as a laptop or the like may be utilized by the user.

The driver of the vehicle 12 may have a software application installed on the mobile communication device 80 or the like that allows the driver to receive requests for the rides via the ride hailing service. The software application on the mobile communication device 80 may display information regarding the ride requested by the user, and may display other information such as a map of directions to the requested destination, and information regarding the account of the user with the ride hailing service.

The mobile communication devices 80, 100 may communicate via a central server 102 that facilitates the transaction between the driver and the user. The central server 102 may operate software that allows the user to request rides from the vehicle 12 and may match the user with local drivers who are willing to accept the ride request. The central server 102 may be operated by an operator of the ride hailing service. The communications between the mobile communication devices 80, 100, and the central server 102 may be transmitted via a cellular tower 104 or another form of communication device.

The user may have an account with the ride hailing service. The account may provide payment options for the user, and may include ratings of the user such as the reliability and quality of the user. The driver may also have an account with the ride hailing service that allows the driver to receive payment for the rides and also includes a rating of the driver such as the reliability and quality of the driver.

The system 10 may be utilized to determine a presence of damage to the rider compartment 16 or the storage compartment 18 of the vehicle 12 that is used with the ride hailing service. The system 10 may perform such an operation in a similar manner as discussed previously herein, including use of the sensors 58, 60, 62, 64, 66 and the ECU 52, and other features. The system 10 as used with the ride hailing service may utilize input provided by the mobile communication devices 80, 100 that may be utilized by the ride hailing service. The mobile communication devices 80, 100 may provide a signal to the ECU 52 indicating that the user has been picked up by a rider and is now present in the vehicle 12. Such a signal may be provided by the driver indicating on the mobile communication device 80 that the rider has been picked up, or the mobile communication device 100 indicating that the rider has been picked up by a signal from the GPS device of the mobile communication device 100. The signal may be utilized to determine a transition between a prior state and a later state as discussed previously. The signal may be utilized by the ECU 52 to determine when the rider is present in the vehicle 12, for comparison of the prior state and the later state to determine the presence of damage. Other sensors such as the door sensors 74, the seat belt sensors 76, and the seat fold sensors 78, may otherwise be utilized in a manner discussed above, as well as the sensors 58, 60, 62, 64, 66.

The output provided by the ECU 52, based on the determination of the presence of damage to the rider compartment 16 or the storage compartment 18, may be similar to the output discussed above. Output that may be provided includes providing the indication of the damage on the mobile communication device 80 that may be utilized by the driver of the vehicle 12. Output that may be provided includes automatically recording the damage or any other output previously discussed.

The output may include providing an indication to the server 102 of the ride hailing service of the presence of damage to the rider compartment 16 or the storage compartment 18. The indication may include a record of damage that was produced by the rider, including a report of the damage. The indication may include one or more images, sounds, or other records of the damage by the rider. A recording of the damage that may have been automatically produced by the system 10 may be provided to the server 102. The indication may include identifying information for the rider. The identifying information may allow the server 102 to match the presence of damage with the rider who may have caused the damage.

The server 102 may then be configured to perform one or more actions in response to the indication of damage to the vehicle 12. The server 102 may present an indication of the damage to the rider, which may be transmitted to the mobile communication device 100 of the rider. FIG. 6, for example, illustrates a display of the mobile communication device 100 that is operating the rider's software application 106 for the ride hailing service. The software application 106 may provide profile information 108 for the rider, account information 110 for the rider, a list of rides 112 for the rider, and a map 114 of the vehicle's 12 location, and any other pick up or drop off location information. The server 102 may cause an indication 116 to be provided on the mobile communication device 100 of an alert of the damage. The server 102 may be aware of which rider caused the damage by the identifying information for the rider being provided to the server 102. The server 102 may cause images or other records of the damage by the rider to be provided to the rider. The server 102 may cause a bill for the damage to be provided to the rider as shown in FIG. 6. In one embodiment, the server 102 may allow the rider to dispute the damage provided to the vehicle 12.

The server 102 may be configured to automatically update the rider's profile, to reduce the rating of the rider for features such as the reliability and quality, based on the damage to the vehicle 12.

The server 102 may be configured to automatically compensate the driver for the damage to the vehicle 12. The driver, for example, may provide an amount of the cost of the damage to the server 102 and may be compensated for that amount to the driver's account.

In one embodiment, the server 102 may be configured to report the damage to the vehicle 12 to disciplinary authorities, such as the police. The record of the damage as well as identifying information for the rider may be provided to the disciplinary authorities. GPS device tracking information for the mobile communication device 100 may be provided to the disciplinary authorities to allow such authorities to find the rider and address the damage to the vehicle 12 with the rider.

In one embodiment, the server 102 may place the vehicle 12, and the driver's account for the ride sharing service, in a null state upon the indication of damage to the vehicle 12. The null state may prevent the vehicle 12 from receiving additional ride requests from other users. The null state may exist until the driver indicates that the damage has been resolved, or the sensors 58, 60, 62, 64, 66 indicate that the damage has been repaired or otherwise resolved.

In one embodiment, the system 10 may be utilized with the vehicle 12 being an autonomous driving vehicle. The system 10 may perform such an operation in a similar manner as discussed previously herein, including use of the sensors 58, 60, 62, 64, 66 and the ECU 52, and other features. The output provided by the ECU 52 in such a configuration may be similar to the outputs discussed previously, and may be utilized to provide instruction for the vehicle 12 to drive to a location. The location may be a vehicle cleaning facility or repair station, or other location that may address the damage within the vehicle 12.

The system 10 as used with an autonomous driving vehicle may be utilized with a ride hailing service as discussed above. The ride hailing service may utilize the autonomous driving vehicle. The system 10 may be utilized with the ride hailing service in a similar manner as discussed previously, with similar outputs. The output may be utilized to provide instruction for the vehicle 12 to automatically drive to a location such as a vehicle cleaning facility or repair station, or other location that may address the damage within the vehicle 12. The instruction for the vehicle 12 may be to drive to another location, such as the facility of disciplinary authorities, for the rider that caused the damage to be apprehended by the authorities. The location may also comprise the side of the road or another designated location for the vehicle 12 to be placed out of operation until the damage is repaired or otherwise resolved. The server 102 may utilized to keep the vehicle 12 out of operation until an individual indicates that the damage has been resolved, or the sensors 58, 60, 62, 64, 66 indicate that the damage has been repaired or otherwise resolved.

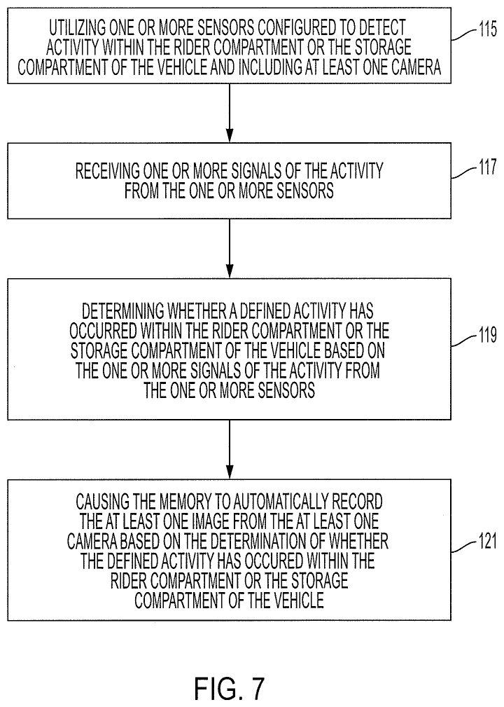

FIG. 7 illustrates steps in a method in which the system 10 is utilized as a camera recording system for the rider compartment 16 or the storage compartment 18 of the vehicle 12. In step 115, the sensors 58, 60, 62, 64, 66 may be configured similarly as discussed above, to detect a respective activity within the rider compartment 16 or the storage compartment 18. The sensors may include at least one camera 58. Each sensor 58, 60, 62, 64, 66 may produce a signal of the activity detected by the respective sensor 58, 60, 62, 64, 66. For example, one or more of the cameras 58 may produce a signal of the images detected by the camera 58, one or more of the moisture sensors 60 may produce a signal representing the moisture detected by the moisture sensor 60, one or more of the audio sensors 62 may produce a signal representing the audio detected by the audio sensor 62, one or more of the pressure sensors 64 may produce a signal representing the pressure or movement detected by the pressure sensor 64, one or more of the motion sensors 66 may produce a signal representing the physical presence or movement detected by the motion sensor 66. The respective signals may be transmitted to the electronic control unit 52 for processing.

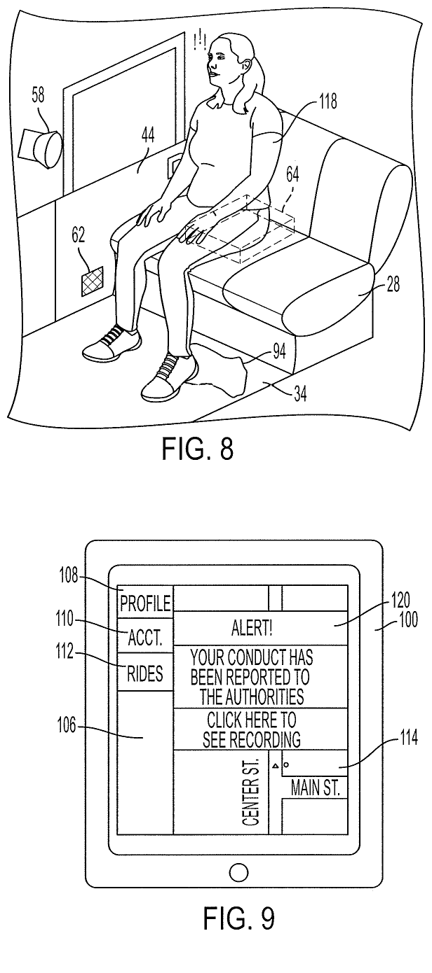

FIG. 8 illustrates an example of the activity that may be detected by the sensors. Sensors in the form of a camera 58, an audio sensor 62, and a pressure sensor 64 are shown in FIG. 8. Moisture sensors 60 and motion sensors 66 may be similarly utilized, although are not shown in FIG. 8. The sensors 58, 62, 64 may be configured to detect activity within the rider compartment 16, shown as a seat of the second row 28 and the rear floor area 34. The camera 58 may detect the activity visually. The audio sensor 62 may detect a sound of the activity. The pressure sensor 64 may detect a pressure or movement of the activity. The moisture sensor 60 may detect the activity in the form of a variation in moisture. A motion sensor 66 may detect a physical presence or movement of the activity.

Referring back to FIG. 7, in step 117 the ECU 52 may receive the signals of the activity from the one or more sensors 58, 60, 62, 64, 66. In step 119, the ECU 52 may be configured to determine whether a defined activity has occurred within the rider compartment 16 or the storage compartment 18 based on the one or more signals of the activity provided by the one or more sensors 58, 60, 62, 64, 66.

The defined activity may comprise an activity that is programmed in the ECU 52 such as the memory 54 of the ECU 52. The defined activity may comprise an activity that is to be met by the signals received from the sensors 58, 60, 62, 64, 66. For example, the defined activity may comprise the presence of damage within the rider compartment 16 or the storage compartment 18. The defined activity may comprise loud noises, argument, or other forms of unruly rider conduct within the rider compartment 16 or the storage compartment 18. For example, FIG. 8 illustrates the rider 118 engaging in unruly conduct in the form of an argument. The defined activity may comprise an object left in the vehicle 12. Other forms of defined activities may be provided as desired. The defined activity may comprise a single activity or multiple defined activities may be programmed in the ECU 52 as desired.

The ECU 52 may determine whether the defined activity has occurred within the rider compartment 16 or the storage compartment 18 based on the signals from one or more of the sensors 58, 60, 62, 64, 66. For example, the ECU 52 may be configured to utilize signals from one of the sensors 58, 60, 62, 64, 66 or signals from a combination of sensors to provide the determination. In an embodiment in which only one or more cameras 58 are utilized, then only camera signals may be utilized by the ECU 52. In an embodiment in which only one or more moisture sensors 60 are utilized, then only moisture sensor signals may be utilized by the ECU 52. In an embodiment in which a combination of sensors is utilized (e.g., both cameras 58 and moisture sensors 60), then the ECU 52 may be configured to determine whether the defined activity has occurred within to the rider compartment 16 or the storage compartment 18 based on the combination of signals.

The ECU 52 may apply an algorithm to the signals provided by the one or more sensors 58, 60, 62, 64, 66 to whether the defined activity has occurred within the rider compartment 16 or the storage compartment 18. The algorithm may be provided based on the type of signals provided by the one or more sensors 58, 60, 62, 64, 66. In an embodiment in which signals are received from one or more cameras 58, an image recognition algorithm may be applied to the signals from the one or more cameras 58. The image recognition algorithm may be applied to at least one image that is captured by the one or more cameras 58 to determine whether the defined activity has occurred within the rider compartment 16 or the storage compartment 18. For example, the image recognition algorithm may be configured to identify visual features in the at least one image that indicate whether the defined activity has occurred within the rider compartment 16 or the storage compartment 18.

In an embodiment in which signals are received from one or more moisture sensors 58, a moisture recognition algorithm may be applied to the signals from the one or more moisture sensors 58. For example, the ECU 52 may determine whether the moisture sensor 58 has detected moisture, and may determine whether the moisture indicates that the defined activity has occurred within the rider compartment 16 or the storage compartment 18.

In an embodiment in which signals are received from one or more audio sensors 62, an audio recognition algorithm may be applied to the signals from the one or more audio sensors 62 to determine whether the defined activity has occurred within the rider compartment 16 or the storage compartment 18. For example, the audio recognition algorithm may be configured to identify audio features in the signal that match features associated with defined activity (e.g., damage) to the rider compartment 16 or the storage compartment 18, such as the sound of structural damage to the vehicle 12, or the sound of an object falling or liquid falling upon the rider compartment 16 or the storage compartment 18, or loud noises or argument is being provided.

In an embodiment in which signals are received from one or more pressure sensors 64, a pressure recognition algorithm may be applied to the signals from the one or more pressure sensors 64 to determine the presence of the defined activity (e.g., damage) to the rider compartment 16 or the storage compartment 18. For example, the pressure recognition algorithm may be configured to identify features in the signal that match features associated with whether the defined activity has occurred within the rider compartment 16 or the storage compartment 18. The features may include pressure of an object or liquid falling upon the rider compartment 16 or the storage compartment 18, or an argument is occurring via sudden movements or the like. The features may include pressure or associated variation in pressure indicating motion that indicates whether the defined activity has occurred within to the vehicle 12.

In an embodiment in which signals are received from one or more motion sensors 66, a motion recognition algorithm may be applied to the signals from the one or more motion sensors 66 to determine whether the defined activity has occurred within the rider compartment 16 or the storage compartment 18. For example, the motion recognition algorithm may be configured to identify features in the signal that match features associated with whether the defined activity has occurred within the rider compartment 16 or the storage compartment 18. The features may include motion of an object or liquid falling upon the rider compartment 16 or the storage compartment 18, or motion of an argument occurring. The features may include movements that indicate whether the defined activity has occurred within the vehicle 12.

The signals from one or more sensors 58, 60, 62, 64, 66 may be processed in combination to determine whether the defined activity has occurred within the rider compartment 16 or the storage compartment 18. In an embodiment in which multiple sensors or types of sensors 58, 60, 62, 64, 66 are utilized, the signals from the multiple sensors or types of sensors 58, 60, 62, 64, 66 may be processed in combination. For example, if multiple cameras 58 are utilized, then the images from multiple cameras 58 may be processed in combination to determine whether the defined activity has occurred. If cameras 58 and audio sensors 62 are both utilized, then the signals from the cameras 58 and the audio sensors 62 may both be processed in combination. The ECU 52 may make a determination based on the signals to determine whether the defined activity has occurred within the rider compartment 16 or the storage compartment 18. For example, if the image algorithm determines that the defined activity has occurred, and the audio algorithm determines that the defined activity has occurred, then the ECU 52 may determine that that the defined activity has occurred. If the image algorithm determines that the defined activity has occurred, but the audio algorithm does not determine that the defined activity has occurred, then the ECU 52 may determine the image algorithm is not certain that the defined activity has occurred, and may determine that the defined activity has not occurred. If the image algorithm and audio algorithm both determine that that the defined activity has not occurred, then the ECU 52 may determine that that the defined activity has not occurred. Multiple combinations of sensors or types of sensors 58, 60, 62, 64, 66 may be processed in combination for the ECU 52 to determine whether the defined activity has occurred.

In step 121, the ECU 52 may cause a memory to automatically record at least one image from the one or more cameras 58 based on the determination of whether the defined activity has occurred within the rider compartment 16 or the storage compartment 18. The recording may record images of the defined activity within the memory. Signals from other sensors 60, 62, 64, 66 may be recorded as well, which may indicate the defined activity occurring within the rider compartment 16 or the storage compartment 18. For example, in an embodiment in which audio sensors 62 are utilized, the audio detected by the audio sensors 62 may be recorded, and may be recorded along with the images of the cameras 58 to form a video recording with sound. Other signals from other sensors 60, 64, 66 may be recorded as well. An individual may later play back any of the recordings to assess what has happened in the vehicle 12. The recording may be stored in the memory 54, or in the memory of a mobile communication device 80, or in the memory of another device as desired. In one embodiment, the ECU 52 may cause the recording to be transmitted to the mobile communication device 80 for view or storage on the mobile communication device 80.

The ECU 52 may cause the memory to record the activity until the defined activity no longer occurs. Thus, if damage is occurring within the rider compartment 16 or the storage compartment 18, the ECU 52 may cause the memory to record the damage until the damage no longer occurs. If an argument is occurring within the rider compartment 16 (or possibly the storage compartment 18), then the ECU 52 may cause the memory to record the argument until the argument no longer occurs.

In one embodiment, the system 10 utilized as a camera recording system, and the vehicle 12, may be utilized with a ride hailing service. The ride hailing service may be configured similarly as previously discussed, with similar components.

The system 10 may be utilized to determine whether a defined activity has occurred within the rider compartment 16 or the storage compartment 18 of the vehicle 12 that is used with the ride hailing service. The system 10 may perform such an operation in a similar manner as discussed previously herein, including use of the sensors 58, 60, 62, 64, 66 and the ECU 52, and other features.

The action by the ECU 52 to cause a memory to automatically record at least one image from the one or more cameras 58 may occur in a similar manner as discussed above.

The ECU 52 may be configured to provide the recording to be transmitted to the server 102 of the ride hailing service. The recording may display the defined activity within the vehicle 12, such as damage to the vehicle 12, unruly activity within the vehicle 12, or a left object in the vehicle 12, among other forms of recordings. The ECU 52 may also be configured to provide identifying information for the rider that has used the ride hailing software and performed the defined activity to be transmitted to the server 102. Thus, if the defined activity is adverse conduct by the rider (e.g., damage or unruly conduct), then the server 102 may be able to match the presence of the adverse conduct with the rider. If the defined activity is a left object in the vehicle, then the server 102 may be able to match the left object with the rider.

The server 102 may then provide perform one or more actions in response to the recording provided from the ECU 52. The server 102 may present an indication of the recording to the rider, which may be transmitted to the mobile communication device 100 of the rider. FIG. 9, for example, illustrates a display of the mobile communication device 100 that is operating the rider's software application 106 for the ride hailing service. The server 102 may cause an indication 120 to be provided on the mobile communication device 100 of an alert of the defined activity. The server 102 may be aware of which rider performed the defined activity by the identifying information for the rider being provided to the server 102. The server 102 may cause the recording to be provided to the rider, so that the rider may view and dispute the recording if necessary. The server 102 may also provide an indication that the recording has been provided to disciplinary authorities.

The server 102 may be configured to automatically update the rider's profile, to reduce the rating of the rider for features such as the reliability and quality, based on the content of the recording.

In one embodiment, the server 102 may be configured to transmit the recording to disciplinary authorities, such as the police. The recording as well as identifying information for the rider may be provided to the disciplinary authorities. GPS device tracking information for the mobile communication device 100 may be provided to the disciplinary authorities to allow such authorities to find the rider and address the activity within the vehicle 12 with the rider.

In one embodiment, the system 10 utilized as a camera recording system may be utilized with the vehicle 12 being an autonomous driving vehicle. The system 10 may perform such an operation in a similar manner as discussed previously herein, including use of the sensors 58, 60, 62, 64, 66 and the ECU 52, and other features.

The system 10 utilized as a camera recording system may be utilized with an autonomous driving vehicle that is used with a ride hailing service as discussed above. The ride hailing service may utilize the autonomous driving vehicle. The system 10 may be utilized with the ride hailing service in a similar manner as discussed previously, and may provide the recording to a device as desired.

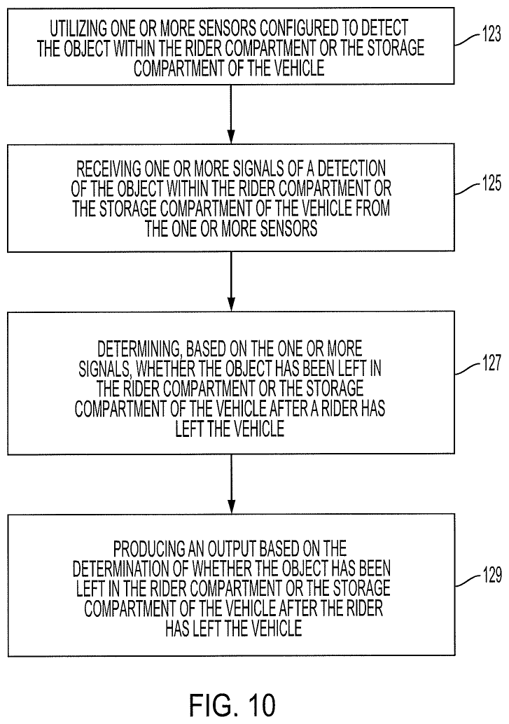

FIG. 10 illustrates steps in a method that may be utilized for the system 10 to determine a presence of an object left in the rider compartment 16 or the storage compartment 18 of the vehicle 12. In step 123, the sensors 58, 60, 62, 64, 66 may be configured to detect the object within the rider compartment 16 or the storage compartment 18. The cameras 58 may be configured to view the object within the rider compartment 16 or the storage compartment 18. The moisture sensors 60 may be configured to detect any moisture that may be associated with the object. The audio sensors 62 may be configured to detect a sound of an object. The pressure sensors 64 may be configured to detect a pressure or movement of the object. The motion sensors 66 may be configured to detect a physical presence or movement of the object.

Each sensor 58, 60, 62, 64, 66 may produce a signal of the object that is detected by the respective sensor 58, 60, 62, 64, 66. For example, one or more of the cameras 58 may produce a signal of the images detected by the camera 58, one or more of the moisture sensors 60 may produce a signal representing the moisture detected by the moisture sensor 60, one or more of the audio sensors 62 may produce a signal representing the audio detected by the audio sensor 62, one or more of the pressure sensors 64 may produce a signal representing the pressure or movement detected by the pressure sensor 64, one or more of the motion sensors 66 may produce a signal representing the physical presence or movement detected by the motion sensor 66. The respective signals may be transmitted to the ECU 52 for processing.

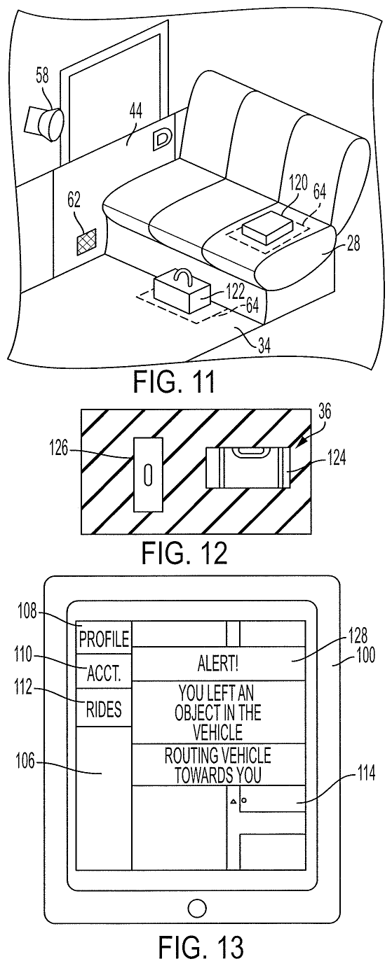

FIGS. 11 and 12 illustrate examples of objects that may be detected by the sensors. Sensors in the form of a camera 58, an audio sensor 62, and pressure sensors 64 are shown in FIG. 11. Moisture sensors 60 and motion sensors 66 may be similarly utilized, although are not shown in FIG. 11. Sensors similarly may be positioned to detect the object within the storage compartment 18 of the vehicle 12 as shown in a top view in FIG. 12. The sensors 58, 62, 64 may be configured to detect the objects left within the rider compartment 16, shown as a seat of the second row 28 and the rear floor area 34. The camera 58 may detect the object visually. The audio sensor 62 may detect a sound of the object. The pressure sensor 64 may detect a pressure or movement of the object. A motion sensor 66 may detect a physical presence or movement of the object. The moisture sensor 60 may detect any moisture associated with the object.

The objects shown in FIG. 11 include a package 120 and a briefcase 122. The package shown in FIG. 11 is positioned on a seat of the second row 28 and the briefcase 122 as shown in FIG. 11 is positioned on the rear floor area 34. Referring to FIG. 12, the objects shown include pieces of luggage 124, 126 positioned on the floor area 36 of the vehicle 12. In other embodiments, other forms of objects including mobile communication devices, wallets, jewelry, keys, other forms of personal property, and other forms of objects may be detected as being left within the vehicle 12.

The camera 58 as shown in FIG. 11 may detect the objects having been left in the vehicle 12 visually. The pressure sensor 64 may detect the pressure of the objects. The audio sensor 62 may detect any sound of the objects. A motion sensor 66 may detect a physical presence or movement of the objects. A moisture sensor 60 may detect a moisture associated with any of the objects. The configuration, number, and location of the sensors 58, 60, 62, 64, 66 may be varied in other embodiments as desired.

Referring back to FIG. 10, in step 125 the ECU 52 may receive the one or more signals of the detection of the object within the rider compartment 16 or the storage compartment 18 from the one or more sensors 58, 60, 62, 64, 66. In step 127, the ECU 52 may determine whether an object has been left in the rider compartment 16 or the storage compartment 18 after a rider has left the vehicle.

The ECU 52 may determine whether an object has been left in the rider compartment 16 or the storage compartment 18 after a rider has left the vehicle based on the signals from one or more of the sensors 58, 60, 62, 64, 66. For example, the ECU 52 may be configured to utilize signals from one of the sensors 58, 60, 62, 64, 66 or signals from a combination of sensors to provide the determination. In an embodiment in which only one or more cameras 58 are utilized, then only camera signals may be utilized by the ECU 52. In an embodiment in which only one or more moisture sensors 60 are utilized, then only moisture sensor signals may be utilized by the ECU 52. In an embodiment in which a combination of sensors is utilized (e.g., both cameras 58 and moisture sensors 60), then the ECU 52 may be configured to determine whether an object has been left in the rider compartment 16 or the storage compartment 18 based on the combination of signals.

The ECU 52 may apply an algorithm to the signals provided by the one or more sensors 58, 60, 62, 64, 66 to determine the presence of the left object in the rider compartment 16 or the storage compartment 18. The algorithm may be provided based on the type of signals provided by the one or more sensors 58, 60, 62, 64, 66. In an embodiment in which signals are received from one or more cameras 58, an image recognition algorithm may be applied to the signals from the one or more cameras 58. The image recognition algorithm may be applied to at least one image that is captured by the one or more cameras 58 to determine whether an object has been left in the compartment 16 or the storage compartment 18. For example, the image recognition algorithm may be configured to identify visual features in the at least one image that indicate whether an object has been left in the rider compartment 16 or the storage compartment 18.

In an embodiment in which signals are received from one or more moisture sensors 58, a moisture recognition algorithm may be applied to the signals from the one or more moisture sensors 58. For example, the ECU 52 may determine whether the moisture sensor 58 has detected moisture and may determine whether the moisture is sufficient in amount to indicate that an object has been left in the rider compartment 16 or the storage compartment 18.

In an embodiment in which signals are received from one or more audio sensors 62, an audio recognition algorithm may be applied to the signals from the one or more audio sensors 62 to determine whether an object has been left in the rider compartment 16 or the storage compartment 18. For example, the audio recognition algorithm may be configured to identify audio features in the signal that match features associated with an object, such as the sound of an object falling or electronic buzzing or other sounds that may be associated with an object.

In an embodiment in which signals are received from one or more pressure sensors 64, a pressure recognition algorithm may be applied to the signals from the one or more pressure sensors 64 to determine whether an object has been left in the rider compartment 16 or the storage compartment 18. For example, the pressure recognition algorithm may be configured to identify features in the signal that match features associated with an object. The features may include pressure of an object. The features may include pressure or associated variation in pressure indicating that an object has been dropped in the rider compartment 16 or a storage compartment 18.

In an embodiment in which signals are received from one or more motion sensors 66, a motion recognition algorithm may be applied to the signals from the one or more motion sensors 66 to determine whether an object has been left in the rider compartment 16 or the storage compartment 18. For example, the motion recognition algorithm may be configured to identify features in the signal that match features associated with an object. The features may include motion of the object falling within the rider compartment 16 or the storage compartment 18.

The signals from one or more sensors 58, 60, 62, 64, 66 may be processed in combination to determine whether an object has been left in the rider compartment 16 or the storage compartment 18. In an embodiment in which multiple sensors or types of sensors 58, 60, 62, 64, 66 are utilized, the signals from the multiple sensors or types of sensors 58, 60, 62, 64, 66 may be processed in combination. For example, if multiple cameras 58 are utilized, then the images from multiple cameras 58 may be processed in combination to determine whether an object has been left. If cameras 58 and pressure sensors 64 are both utilized, then the signals from the cameras 58 and the pressure sensors 64 may both be processed in combination. The ECU 52 may make a determination based on the signals to determine whether an object has been left in the rider compartment 16 or the storage compartment 18. For example, if the image algorithm determines the presence the object, and the pressure recognition algorithm determines the presence of the object, then the ECU 52 may determine that the object has been left. If the image algorithm determines the presence of the object, but the pressure recognition algorithm does not determine the presence of the object, then the ECU 52 may determine the image algorithm is not certain in the determination of the presence of the object, and that the object has not been left. If the image algorithm and pressure recognition algorithm both determine that the object is not present, then the ECU 52 may determine that the object is not present. Multiple combinations of sensors or types of sensors 58, 60, 62, 64, 66 may be processed in combination for the ECU 52 to determine whether the object has been left.

The ECU 52 may make a determination of whether an object has been left in the rider compartment 16 or the storage compartment 18 based on a comparison of a prior state with a later state. For example, the ECU 52 may receive the signals from the one or more sensors 58, 60, 62, 64, 66 during a prior state within the rider compartment 16 or the storage compartment 18. The ECU 52 may then receive the signals from the one or more sensors 58, 60, 62, 64, 66 during a later state and compare the signals from the prior state to the later state. The ECU 52 may then make a determination of whether an object has been left based on the change from the prior state to the later state. For example, if cameras 58 are utilized, then at least one of a plurality of images from multiple cameras 58 during a prior state (e.g., a time prior to the rider entering the vehicle) may be compared to at least one of a plurality of images from a later state (e.g., a time after the rider has left the vehicle). If the suitcase 122, for example, was not present on the rear floor area 34 during the prior state, and then the suitcase 122 is present on the rear floor area 34 during a later state, then the ECU 52 may make a determination of the presence of a left object in the rider compartment 16. Any of the signals from the sensors 58, 60, 62, 64, 66 may be compared from a prior state to a later state within the rider compartment 16 or the storage compartment 18, either solely or in combination to determine whether the object has been left.

Sensors may be utilized to determine a transition between a prior state and a later state. Such sensors may include the door sensors 74, the seat belt sensors 76, and the seat fold sensors 78. Signals from such sensors may be transmitted to the ECU 52 for the ECU 52 to make a determination that a rider is present within the vehicle 12 by either entering or exiting the vehicle 12. For example, if the door sensors 74 detect a door has opened, and the seat belt sensor 76 detects that a seat belt has been engaged with a buckle, then the ECU 52 may determine that a rider is present in the vehicle 12. The time prior to the rider in the vehicle 12 may be considered a prior state for the vehicle 12 and the time following the rider being in the vehicle 12 may be considered a later state. The ECU 52 may compare the signals from the prior state to the later state to determine if the rider has left an object in the vehicle 12. The comparison may occur after the rider leaves the vehicle 12, to determine whether the rider has left the object in the vehicle 12. The seat fold sensors 78 may be similarly utilized to determine if a rider has moved to the third row 30, or has accessed the storage compartment 18. The door sensors 74 may be similarly utilized to determine if the storage compartment 18 has been accessed and an object has been placed therein. Signals from one or more of the sensors 58, 60, 62, 64, 66 may also be utilized to determine a transition between a prior state and a later state.

In step 129, the ECU 52 may produce an output based on the determination of whether the object has been left in the rider compartment 16 or the storage compartment 18 after the rider has left the vehicle. The output may be provided in a variety of forms. In one embodiment, the output may comprise an indicator provided to an individual of object left in the vehicle 12. Referring to FIG. 2, the indicator may comprise a visual indicator 92 that is provided to an individual, and may be provided on one or more of the displays 68. The visual indicator 92 as shown in FIG. 2 may comprise a word, such as “alert,” or may have another form such as a symbol, a light, or another visual form. The visual indicator may comprise lights, including illumination by one or more of the indicator devices 70. In one embodiment, the indicator may be a sound produced by one or more of the indicator devices 70. The indicator may be produced either internally within the vehicle 12 or externally. For example, the front lights 48 or the rear lights 50, or the car horn, may illuminate or sound to provide an external indication. In one embodiment, an internal indicator device 70 in the form of a dome light or other form of internal light may illuminate to not only indicate the presence of the left object, but also allow an individual to better see within the vehicle to find the left object. An indicator may be provided on a mobile communication device 80 or other device. For example, FIG. 3 illustrates a visual indicator 92 may be provided on the mobile communication device 80, for a rider that left the vehicle 12 to be notified that he or she left an object therein. The indicator may be provided remotely, on a remote device if desired.

In one embodiment, the output may comprise automatically switching a view of one or more of the displays 68 to display the presence of the left object. The ECU 52 may determine a location of the left object and display the left object on the view of the displays 68. The view of a remote device may also be switched to show the left object.

In one embodiment, the output may comprise automatically causing the presence of the left object to be recorded in the memory 54 or another form of memory. The detections from one or more of the sensors 58, 60, 62, 64, 66 may be automatically recorded that indicate the left object. In an embodiment in which cameras 58 are utilized, at least one image from the cameras 58 of the left object may be automatically recorded in the memory 54 or another form of memory. An individual may later play back the recording to assess what happened in the vehicle 12 and what object was left in the vehicle. The output may comprise automatically causing the presence of the left object to be recorded in the memory of the mobile communication device 80 if desired. Other forms of output may be provided in other embodiments.

In one embodiment, the system 10 and the vehicle 12 may be utilized with a ride hailing service. The ride hailing service may be configured similarly as previously discussed, with similar components.

The system 10 may be utilized to determine a presence of an object left in the rider compartment 16 or the storage compartment 18 of the vehicle 12 that is used with the ride hailing service. The system 10 may perform such an operation in a similar manner as discussed previously herein, including use of the sensors 58, 60, 62, 64, 66 and the ECU 52, and other features. The system 10 as used with the ride hailing service may utilize input provided by the mobile communication devices 80, 100 that may be utilized by the ride hailing service. The mobile communication devices 80, 100 may provide a signal to the ECU 52 indicating that the user has been picked up by a rider and is now present in the vehicle 12. Such a signal may be provided by the driver indicating on the mobile communication device 80 that the rider has been picked up, or the mobile communication device 100 indicating that the rider has been picked up by a signal from the GPS device of the mobile communication device 100. The signal may be utilized to determine a transition between a prior state and a later state as discussed previously. The signal may be utilized by the ECU 52 to determine when the rider is present in the vehicle 12, for comparison of the prior state and the later state to determine the presence of a left object. Other sensors such as the door sensors 74, the seat belt sensors 76, and the seat fold sensors 78, may otherwise be utilized in a manner discussed above, as well as the sensors 58, 60, 62, 64, 66.

The output provided by the ECU 52 based on the determination of the presence of an object left in the rider compartment 16 or the storage compartment 18 may be similar to the output discussed above. Output that may be provided includes providing the indication of the left object on the mobile communication device 80 that may be utilized by the driver of the vehicle 12. Output that may be provided includes automatically recording the left object or any other output previously discussed.

The output may include providing an indication to the server 102 for a ride hailing service that an object has been left in the rider compartment 16 or the storage compartment 18 after a rider has left the vehicle. The indication may include a record of the object that was left by a rider. The indication may include one or more images or other records of the object. A recording of the object that may have been automatically produced by the system 10 may be provided to the server 102. The indication may include identifying information for the rider. The identifying information may allow the server 102 to match the left object with the rider.

The server 102 may then provide perform one or more actions in response to the indication of the left object in the vehicle 12. The server 102 may present an indication of the left object to the rider, which may be transmitted to the mobile communication device 100 of the rider. FIG. 13, for example, illustrates a display of the mobile communication device 100 that is operating the rider's software application 106 for the ride hailing service. The server 102 may cause an indication 128 to be provided on the mobile communication device 100 of an alert of the left object. The server 102 may be aware of which rider left the object based on the identifying information for the rider being provided to the server 102. The server 102 may cause images or other records of the object left by the rider to be provided to the rider. In one embodiment, the server 102 may allow the rider to dispute whether the left object is the rider's object.

In one embodiment, the server 102 may be configured to provide tracking information for the GPS device of the mobile communication device 100 to be transmitted to the driver of the vehicle 12. The driver of the vehicle 12 may then be able to locate the rider that has exited the vehicle and return the left object to the driver. In an embodiment in which the left object comprises the mobile communication device 100 the server 102 may be configured to transmit notifications to designated contacts for the rider, or may be configured to direct the driver to a designated meeting point for the rider to retrieve the left object. In one embodiment, the server 102 may provide an indication to the rider to pick up the left object at a designated location.

In one embodiment, the server 102 may place the vehicle 12, and the driver's account for the ride sharing service, in a null state upon the indication of a left object in the vehicle 12. The null state may prevent the vehicle 12 from receiving additional ride requests from other users. The null state may exist until the driver indicates that the left object has been retrieved by the rider or has been secured by the driver.

In one embodiment, the system 10 may be utilized with the vehicle 12 being an autonomous driving vehicle. The system 10 may perform such an operation in a similar manner as discussed previously herein, including use of the sensors 58, 60, 62, 64, 66 and the ECU 52, and other features. The output provided by the ECU 52 in such a configuration may be similar to the outputs discussed previously, and may be utilized to provide instruction for the vehicle 12 to automatically drive to a location. The location may be a designated location for meeting with a rider to return the left object. The autonomous driving vehicle may be configured to track a location of the rider via a GPS device of a mobile communication device of the rider and may be configured to drive towards the rider after the rider has left the vehicle.

The system 10 as used with an autonomous driving vehicle may be utilized with a ride hailing service as discussed above. The ride hailing service may utilize the autonomous driving vehicle. The system 10 may be utilized with the ride hailing service in a similar manner as discussed previously, with similar outputs. The output may be utilized to provide instruction for the vehicle 12 to automatically drive to a designated location for meeting with a rider to return the left object. The autonomous driving vehicle may be configured to track a location of the rider via a GPS device of a mobile communication device of the rider, and may be configured to drive towards the rider after the rider has left the vehicle. The instruction for the vehicle 12 may be to drive to another location, which may comprise the side of the road or another designated location for the vehicle 12 to be placed out of operation until the left object is retrieved. The server 102 may utilized to keep the vehicle 12 out of operation until an individual indicates that the left object has been retrieved, or the sensors 58, 60, 62, 64, 66 indicate that the left object has been retrieved.

The systems, methods, and devices disclosed herein may be utilized to generally view and record areas of the rider compartment and the storage compartment, or may be used according to the other methods disclosed herein. The systems, methods, and devices disclosed herein may be utilized to keep track of pets, children, and luggage among other objects, within the vehicle. The recordings may be transmitted to other devices, for view by disciplinary authorities or ride sharing services, among others. Other features of the system may include an automated service schedule that an automated vehicle follows for service, cleaning, and repair of the vehicle.

In one embodiment, the communication to the server of the ride hailing service may occur via the mobile communication device 80. For example, the communication device 56 may communicate to the mobile communication device 80, which thus communicates with the server of the ride hailing service to perform the methods disclosed herein.

The system and devices disclosed herein may be installed separately within a vehicle, or may be preinstalled with a vehicle at time of sale. The systems, methods, and devices disclosed herein may be combined, substituted, modified, or otherwise altered across embodiments as desired. The disclosure is not limited to the systems and devices disclosed herein, but also methods of utilizing the systems and devices.

Exemplary embodiments of the disclosure have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A system for determining a presence of damage to a rider compartment or a storage compartment of a vehicle, the system comprising:
one or more sensors configured to detect activity within the rider compartment or the storage compartment of the vehicle and including at least one camera;
one or more displays configured to display an image from the at least one camera; and
an electronic control unit configured to:
receive one or more signals of the activity from the one or more sensors,
determine the presence of damage to the rider compartment or the storage compartment of the vehicle based on the one or more signals, and
automatically switch a view of the one or more displays to display the presence of the damage in response to the determination of the presence of the damage to the rider compartment or the storage compartment of the vehicle.

2. The system of claim 1, wherein the one or more sensors further include one or more of a moisture sensor, an audio sensor, a pressure sensor, or a motion sensor.

3. The system of claim 1, wherein the electronic control unit is configured to determine the presence of damage to the rider compartment or the storage compartment of the vehicle based on the image or one or more other images captured by the at least one camera.

4. The system of claim 3, wherein the electronic control unit is configured to perform an image recognition algorithm on the image or the one or more other images to determine the presence of damage to the rider compartment or the storage compartment of the vehicle.

5. The system of claim 1, wherein the damage includes one or more of: a material deposited within the rider compartment or the storage compartment of the vehicle; or a variation in an integrity of at least a portion of the rider compartment or the storage compartment of the vehicle.

6. The system of claim 1, wherein the electronic control unit is configured to produce an output based on the determination of the presence of the damage to the rider compartment or the storage compartment of the vehicle and the output includes an indication to a server for a ride hailing service of the presence of damage to the rider compartment or the storage compartment of the vehicle.

7. The system of claim 6, wherein the output includes an indication to the server of identifying information for a rider in the vehicle that has utilized a ride hailing software application of the ride hailing service.

8. The system of claim 1, wherein the electronic control unit is configured to produce an output based on the determination of the presence of the damage to the rider compartment or the storage compartment of the vehicle and the vehicle is an autonomous driving vehicle, and the output includes instruction for the autonomous driving vehicle to drive to a location.

9. The system of claim 8, wherein the location is a vehicle cleaning facility.

10. A camera recording system for a rider compartment or a storage compartment of a vehicle, the system comprising:
one or more sensors configured to detect activity within the rider compartment or the storage compartment of the vehicle and including at least one camera;
a memory configured to record at least one image from the at least one camera;
one or more displays configured to display the at least one image from the at least one camera; and
an electronic control unit configured to:
receive one or more signals of the activity from the one or more sensors,
determine whether a defined activity has occurred within the rider compartment or the storage compartment of the vehicle based on the one or more signals of the activity from the one or more sensors,
automatically switch a view of the one or more displays to display the occurrence of the defined activity in response to the determination of whether the defined activity has occurred within the rider compartment or the storage compartment of the vehicle, and
cause the memory to automatically record the at least one image from the at least one camera based on the determination of whether the defined activity has occurred within the rider compartment or the storage compartment of the vehicle.

11. The camera recording system of claim 10, wherein the one or more sensors further comprise at least one of a moisture sensor, an audio sensor, a pressure sensor, or a motion sensor.

12. The camera recording system of claim 10, wherein the defined activity comprises a presence of damage within the rider compartment or the storage compartment of the vehicle.

13. The camera recording system of claim 10, wherein the electronic control unit is configured to cause the recorded at least one image to be transmitted to a mobile communication device.

14. The camera recording system of claim 10, wherein the electronic control unit is configured to:
cause the recorded at least one image to be transmitted to a server for a ride hailing service, and
cause identifying information for a rider in the vehicle that has utilized a ride hailing software application of the ride hailing service and performed the defined activity to be transmitted to the server.

15. A system for determining a presence of an object left in a rider compartment or a storage compartment of a vehicle, the system comprising:
one or more sensors configured to detect the object within the rider compartment or the storage compartment of the vehicle and including at least one camera;
one or more displays configured to display an image from the at least one camera; and
an electronic control unit configured to:
receive one or more signals of a detection of the object within the rider compartment or the storage compartment of the vehicle from the one or more sensors,
determine, based on the one or more signals, whether the object has been left in the rider compartment or the storage compartment of the vehicle after a rider has left the vehicle, and
automatically switch a view of the one or more displays to display the object in response to the determination of whether the object has been left in the rider compartment or the storage compartment of the vehicle after the rider has left the vehicle.

16. The system of claim 15, wherein the one or more sensors further include one or more of a moisture sensor, an audio sensor, a pressure sensor, or a motion sensor.

17. The system of claim 15, wherein the electronic control unit is configured to determine whether the object has been left in the rider compartment or the storage compartment of the vehicle based on a comparison of at least one first image captured by the at least one camera from a time prior to the rider entering the vehicle with at least one second image captured by the at least camera from a time after the rider has left the vehicle.

18. The system of claim 15, wherein the object comprises personal property of the rider.

19. The system of claim 15, wherein the electronic control unit is configured to produce an output based on the determination of whether the object has been left in the rider compartment or the storage compartment of the vehicle after the rider has left the vehicle, and the output includes an indication to a server for a ride hailing service that the object has been left in the rider compartment or the storage compartment of the vehicle after the rider has left the vehicle.

20. The system of claim 15, wherein the vehicle is an autonomous driving vehicle and the electronic control unit is configured to produce an output based on the determination of whether the object has been left in the rider compartment or the storage compartment of the vehicle after the rider has left the vehicle and, and the output includes instruction for the autonomous driving vehicle to drive toward the rider after the rider has left the vehicle.
